(19) United States
(12) Patent Application Publication
(10) Pub. No.: US 2023/0333366 A1
(43) Pub. Date: Oct. 19, 2023

(54) APPARATUS FOR CLEANING AN OPTICAL SURFACE IN AN OPTICAL DEVICE

(71) Applicant: ExcelSense Technologies Corp., Richmond (CA)

(72) Inventors: Nima Nabavi, Vancouver (CA); Ian Law Bell, North Vancouver (CA); Joubin Nayeri, Burnaby (CA); Colin Alexander Nyuli, Vancouver (CA)

(21) Appl. No.: 18/002,855

(22) PCT Filed: Jun. 22, 2021
(86) PCT No.: PCT/CA2021/050851

§ 371 Date: Dec. 21, 2022

Related U.S. Application Data
(60) Provisional application No. 63/042,472, filed on Jun. 22, 2020.

(51) Int. Cl. G02B 27/00; G02B 1/14; G02B 1/18

(52) U.S. Cl. CPC G02B 27/0006; G02B 1/14; G02B 1/18

(57) ABSTRACT

An apparatus for cleaning an optical surface, at least a portion of the surface being covered by an optically transparent liquid film, includes a wiper including an edge extending across at least a portion of the optical surface and urged into close proximity with the optical surface, the edge being defined between a leading face and a trailing face. The apparatus also includes an actuator operable to move of at least one of the wiper and the optical surface to cause the wiper to traverse the optical surface such that the leading face dislodges contaminants entrained in the liquid film or adhered to the optical surface to produce a cleaned portion of the optical surface. The apparatus further includes a liquid applicator disposed behind the trailing face of the wiper and operable to dispense liquid for renewing the liquid film on the cleaned portion of the optical surface.

### BACKGROUND

### 1. Field

This disclosure relates generally to optical devices and more particularly to the cleaning of an optical surface used in an optical device.

### 2. Description of Related Art

Cameras, rangefinders, and other optical devices generally have at least one optical surface exposed to the surrounding environment. The exposed optical surface may be an outer surface of an optical grade window, a lens, or other optical element that encloses a housing and transmits light to or from the optical device within the housing. The optical element thus protects sensitive optical components enclosed within the housing. The exposed optical surface may however accumulate contaminants such as water, dust particles, and other debris over time that degrade optical performance. In cases where the optical surface is exposed to a harsh environment the optical surface may become too quickly contaminated to rely on periodic manual cleaning. This is particularly problematic in mining and other industrial environments, or for installations in remote locations where it is difficult or dangerous to access the optical device for manual cleaning. In some applications, a lack of access for manual cleaning may actually prohibit deployment of the optical device.

Existing automated cleaning systems generally operate by spraying a cleaning fluid onto the optical element to loosen any accumulated debris. A wiper blade similar to a windshield wiper is then actuated to remove excess fluid from the optical element. One particular problem associated with spray cleaning systems is consumption of the cleaning fluid, which depending on the frequency of automated cleaning may need relatively frequent replenishment. Such automates systems would thus still require periodic manual maintenance.

There remains a need for apparatus and methods for performing automated cleaning of optical surfaces.

### SUMMARY

In accordance with one disclosed aspect there is provided an apparatus for cleaning an optical surface, at least a portion of which is covered by an optically transparent liquid film, the liquid film disposed to protect the optical surface while transmitting light to an underlying optical device. The apparatus includes a wiper including an edge extending across at least a portion of the optical surface and urged into close proximity with the optical surface, the edge being defined between a leading face and a trailing face. The apparatus also includes an actuator operable to move of at least one of the wiper and the optical surface to cause the wiper to traverse the optical surface such that the leading face dislodges contaminants entrained in the liquid film or adhered to the optical surface to produce a cleaned portion of the optical surface. The apparatus further includes a liquid applicator disposed to dispense liquid for renewing the liquid film on the cleaned portion of the optical surface, and the edge of the wiper includes a sufficiently rigid material selected to resist deformation that would permit contaminants to pass under the wiper while traversing the optical surface.

The leading face may be oriented at an obtuse angle to a portion of the optical surface to be traversed to dispose the leading face to lift the contaminants away from the optical surface while traversing.

The edge of the wiper may be urged into close proximity with the optical surface by one of a compliant element configured to force the wiper and the optical surface toward each other, a compliant element configured to provide an adjustable force for forcing the wiper and the optical surface toward each other, or a material compliance associated with the edge of the wiper.

The optical device may be disposed within an inner housing including a window disposed to protect the underlying optical device, and the optical surface may include a surface of the window, and the wiper may be mounted to an outer housing enclosing the first housing, and may further include a compliant element disposed between the inner housing and the outer housing, the compliant element being configured to urge the first housing into contact with the wiper.

The edge of the wiper may include a metallic material.

The edge of the wiper may include a thermoplastic material having a Shore A durometer of at least 90.

The optical surface may include a surface of a window disposed to protect the underlying optical device and the actuator may be operable to cause at least one of a rotation of the window, and a linear displacement of the window.

The edge of the wiper may be disposed at an angle that is less than a right angle to a traversing direction with respect to the optical surface, such that dislodged contaminants will have a component of motion along the edge of the wiper during traversing.

The optical surface may include a surface of a circular window disposed to protect the underlying optical device, the optical device having a field of view through a portion of the window, and the actuator may be operable to cause a rotation of the window about a central axis, the central axis being disposed outside the field of view portion of the window.

The wiper and liquid applicator may be enclosed within a housing that extends over a portion of the optical surface within a field of view of the optical device, the housing vignetting a first portion of light impinging on the optical surface while a second portion of light within the field of view of the optical device is transmitted by the optical surface, the second portion of light being sufficient to produce an image of the field of view of the optical device.

The actuator may be configured to cause movement in a first direction to cause the leading face of the wiper to traverse the optical surface to produce the cleaned portion of the optical surface while the liquid applicator renews the liquid film on the cleaned portion of the optical surface.

The actuator may be configured to cause movement in a first direction to cause the leading face of the wiper to traverse the optical surface to produce the cleaned portion of the optical surface, the actuator being further configured to cause movement in a second direction to cause the liquid applicator to renew the liquid film on the cleaned portion of the optical surface.

The trailing face of the wiper may be disposed at an acute angle to the optical surface such that the respective angles of the leading face and trailing face define an area of contact at the edge for contacting the optical surface.

The leading face and trailing face of the wiper may be formed to cause the area of contact to have a uniformity generally corresponding to a surface roughness of the optical surface such that the area of contact remains submerged within a film thickness of the liquid film as the wiper traverses the optical surface.

The liquid applicator may include a liquid reservoir, and a compliant seal disposed behind the trailing face of the wiper, the compliant seal being configured to dispense liquid from the liquid reservoir for renewing the liquid film.

The liquid reservoir may include an opening disposed proximate to the optical surface and the compliant seal may be configured to enclose the opening to limit discharge of the liquid from the liquid reservoir when the wiper is not moving relative to the optical surface.

The compliant seal may include a first portion disposed proximate the trailing face of the wiper and a second portion spaced apart from the trailing face, and the apparatus may further include an applicator shield extending along the second portion of the compliant seal, the applicator shield being operably configured to protect the second portion of the compliant seal and to prevent ingress of contaminants into the volume of the liquid reservoir.

The compliant seal may include an energized seal having an elastomeric portion and an energizing portion, the energizing portion operably configured to urge the elastomeric portion into contact with the optical surface.

The liquid applicator may include an absorbent material disposed in contact with or proximate the optical surface, the absorbent material acting as a reservoir for holding liquid, a portion of which is dispensed from the absorbent material for renewing the liquid film.

The liquid applicator may include a spray nozzle in communication with a liquid reservoir, the spray nozzle being oriented to spray liquid onto the optical surface.

The optical surface may be provided by an optical element disposed to transmit light to the optical device, the optical element including a plurality of narrow channels extending through the optical element and the liquid applicator may include a liquid reservoir in communication with the plurality of channels, the plurality of channels having respective openings at the optical surface operable to deliver liquid from the liquid reservoir to the optical surface for renewing the liquid film.

The liquid reservoir may be pressurized to a pressure level that is sufficient to cause liquid to flow through the plurality of narrow channels and form the liquid film on the optical surface while not providing sufficient force to overcome the surface tension in the liquid film.

The optical surface may include a surface of a circular window disposed to protect the underlying optical device, and the apparatus may further include a housing covering a portion of the optical surface and defining an opening corresponding to the portion of the optical surface covered by the optically transparent liquid film, the wiper being disposed on the housing adjacent to the opening and extending outwardly from a location proximate a center of the circular window toward a periphery of the window, the actuator being operably configured to cause the window to rotate relative to the housing to cause the wiper to dislodge contaminants on a portion of the optical surface that passes under the wiper into the housing, and the liquid applicator being disposed to renew the liquid film on the cleaned portion of the optical surface that emerges from the housing.

The housing may include a peripheral portion that extends around the opening along a peripheral portion of the window such that the housing and the peripheral portion of the housing enclose the opening.

The housing may include a seal disposed surrounding the opening.

The peripheral portion of the housing may progressively narrow in a direction of rotation of the window with respect to the housing such that contaminants on the optical surface become spaced apart from the peripheral portion of the housing as the window rotates relative to the housing.

The wiper may include a first wiper and a second wiper, wherein the second wiper includes the edge including the sufficiently rigid material selected to resist deformation, the first wiper including an edge fabricated from a material having a greater compliance than the edge of the second wiper, and the second wiper may be operably configured to dislodge contaminants that pass under the first wiper while traversing the optical surface.

The edge of the second wiper may include a metallic material and the edge of the first wiper may include a thermoplastic material having a Shore A durometer of at least 90.

The wiper and liquid applicator may be fabricated as a unitary body.

The liquid applicator may include a liquid applicator edge disposed in spaced apart relation to the edge of the wiper, the liquid applicator edge being in liquid communication with a liquid reservoir for dispensing liquid under the liquid applicator edge and under the edge of the wiper onto the optical surface.

The unitary body may include at least one laterally sculpted portion between a mounting portion and an engagement portion of the wiper, the at least one laterally sculpted portion being configured to facilitate flexing of the engagement portion with respect to the mounting portion to permit the edge of the wiper and the liquid applicator edge to each engage the optical surface.

The wiper may be fabricated from one of a Hydroxyacetone or a polyurethane material. Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1A is a perspective view of an apparatus for cleaning an optical surface in accordance with a first disclosed embodiment;

FIG. 1B is a cross-sectional view of the apparatus shown in FIG. 1A taken along a line A-A in FIG. 1A;

FIG. 2A is a perspective view of an integrated optical system including an apparatus for cleaning an optical surface in accordance with another disclosed embodiment;

FIG. 2B is a partially cut away perspective view of the optical system shown in FIG. 2A

FIG. 2C is an exploded view of a portion of the optical system shown in FIG. 2A

FIG. 2D is a cross-sectional view of a portion of the optical system shown in FIG. 2C in an assembled state;

FIG. 2E is a front elevational view of a cleaning apparatus of the optical system shown in FIG. 2A;

FIG. 3 is a front elevational view of an example of another embodiment of a cleaning apparatus and optical system;

FIG. 4 is a front elevational view of an optical system in accordance with another disclosed embodiment;

FIG. 5 is a is a front elevational view of an optical system in accordance with yet another disclosed embodiment;

FIG. 6A is a cross-sectional view taken along the line C-C in FIG. 2E showing an alternative embodiment of a first portion of a wiper used in the optical system shown in FIG. 2E;

FIG. 6B is a cross-sectional view taken along the line D-D in FIG. 2E showing an alternative embodiment of a second portion of a wiper used in the optical system shown in FIG. 2E;

FIG. 6C is a cross-sectional view of an alternative embodiment of the wiper portions shown in FIGS. 6A and 6B;

FIG. 7 is a cross-sectional view of an alternative liquid applicator embodiment;

FIG. 8 is a cross-sectional view of another liquid applicator embodiment;

FIG. 9A is a perspective view of an optical window for implementing yet another liquid applicator embodiment;

FIG. 9B is a schematic cross-sectional view of the optical window shown in FIG. 9A;

FIG. 10A is a perspective view of an apparatus for cleaning an optical surface in accordance with another disclosed embodiment;

FIG. 10B is a schematic cross-sectional view of the apparatus shown in FIG. 10A;

FIG. 11A is a perspective view of a cleaning apparatus in accordance with a further disclosed embodiment;

FIG. 11B is a cross-sectional view of the apparatus shown in FIG. 11A.

FIG. 12A is a perspective view of a wiper in accordance with a further disclosed embodiment; and

FIG. 12B is a cross-sectional view of the wiper shown in FIG. 12A.

### DETAILED DESCRIPTION

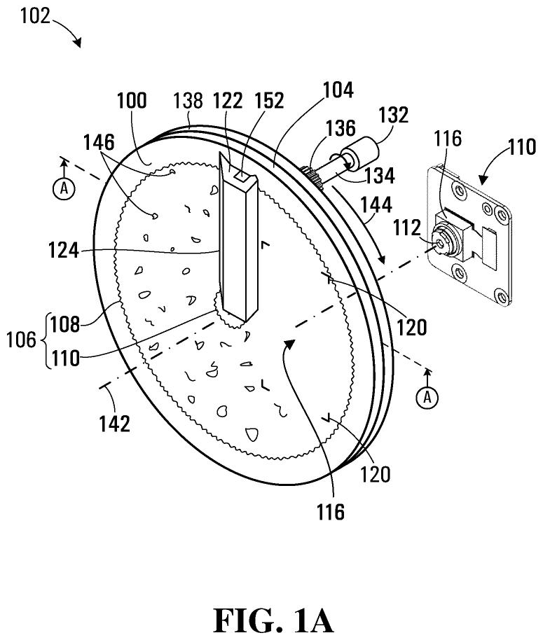

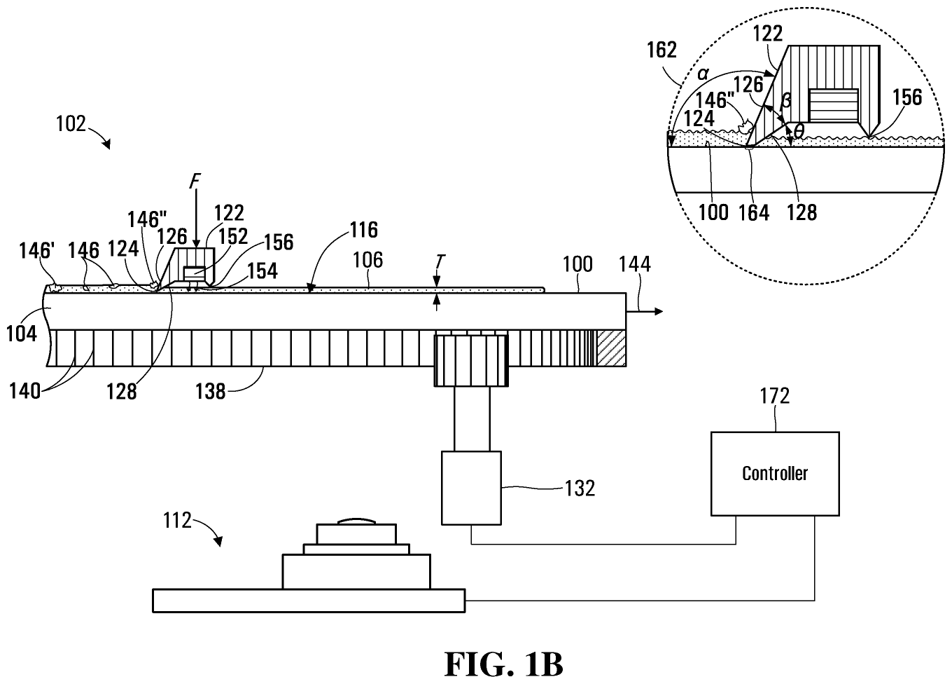

Referring to FIG. 1A, in accordance with one disclosed aspect an apparatus for cleaning an optical surface 100 is shown generally at 102. In the embodiment shown the optical surface is provided by a window 104, but in other embodiments the optical surface may be a surface of a lens, a prism, mirror, or any other optical element. At least a portion of the optical surface 100 is covered by an optically transparent liquid film 106. In this embodiment the portion covered by the liquid film extends generally between the wavy lines 108 and 110. The liquid film 106 is disposed to protect the optical surface 100 while transmitting light to an underlying optical device 112. In this embodiment the optical device 112 is a camera that includes a lens 114 that captures light through a portion 116 of the optical surface 100 and produces an image at an image sensor 118 of the camera. In other embodiments that optical device 112 may be any optical device, such as a camera, laser, a light, or a rangefinder. In some embodiments light may thus be emitted by the optical device and transmitted out through the optical surface 100.

The apparatus 102 includes a wiper 122, which has an edge 124 extending across a portion of the optical surface 100. Referring to FIG. 1B, the wiper 122 is shown in enlarged detail in a cross-sectional view taken along the line A-A in FIG. 1A. The edge 124 of the wiper 122 is defined between a leading face 126 and a trailing face 128. The wiper 122 is urged into close proximity with the optical surface by a force F. In one embodiment the wiper may be mounted relative to the optical surface 100 with at least the edge 124 of the wiper in a strained condition, such that a compliance associated with the edge of the wiper provides the force F. A suitable compliance may be provided by a thermoplastic material such as polyethylene (UHMW) or acetal (Delrin®).

Referring back to FIG. 1A, the apparatus 102 further includes an actuator 132 operable to cause a relative motion between the wiper 122 and the optical surface 100. In the embodiment shown the actuator 132 is coupled via a shaft 134 to a gear 136. The optical surface 100 is mounted on an annular ring 138, which has a corresponding gear 140 formed on an inner race of the ring. The actuator 132 delivers a drive torque via the shaft 134, which is coupled via the gears 136 and 140 to the annular ring 138. The delivered torque causes rotation of the optical surface 100 about a central axis 142 of the optical surface, resulting in a relative traversing motion between the optical surface and the wiper 122. In this embodiment, the traversing movement of the optical surface 100 is in a direction indicated by an arrow 144. The traversing movement of the wiper with respect to the optical surface 100 causes the leading face 126 of the wiper 122 to dislodge contaminants 146 (FIG. 1B) that become entrained in the liquid film 106 or adhered to the optical surface 100 to produce a cleaned portion (i.e. portion 116) of the optical surface. In other embodiments the traversing movement 144 may be provided by moving the wiper with respect to the optical surface 100.

The apparatus 102 also includes a liquid applicator 152 disposed behind the trailing face 128 of the wiper 122. The liquid applicator 152 is operable to dispense a liquid 154 for renewing the liquid film 106 on the cleaned portion 116 of the optical surface. Various embodiments for implementing the liquid applicator 152 are described in more detail below. In this embodiment the wiper 122 includes a trailing applicator shield 156 that prevents ingress of contaminants into the liquid film 106 in the region between the liquid applicator 152 and the optical surface 100. The applicator shield 156 may also assist in regulating a thickness T of the liquid film 106 dispensed by the liquid applicator 152.

Suitable liquids for providing the liquid film 106 may have properties that cause the liquid to uniformly wet the optical surface 100 and remain stable under environmental conditions that the apparatus 102 will be subjected to. It may also be desirable that adhesive forces between the liquid and the optical surface 100 are greater than adhesive forces between the liquid and typical contaminants 146. Under these conditions many typical contaminant particles will tend to float within the liquid film 106 rather than adhere to the optical surface 100 underlying the liquid film (as best shown for contaminants 146 in FIG. 1B). Other liquid properties that may be desirable depending on the application include stable viscosity, low vapor pressure, and hydrolytic stability. In one embodiment the liquid may be a hydraulic oil. In some embodiments the hydraulic oil may include constituents such as silicone that cause the liquid film 106 to have hydrophobic characteristics, which reduces the likelihood of water becoming entrained within the liquid film. These liquids will tend to cause water droplets to float on top of the liquid film 106, where they can be easily removed by the wiper 122, rather than pass under the wiper to the liquid applicator. Additionally, the liquid should also have suitable optical properties. As an example, the liquid may be selected based on high optical transmittance over a wavelength range associated with the optical device 112. The liquid may also be selected to have a refractive index that is close to a refractive index of the material of the window 104, which reduces the optical effect of scratches in the optical surface 100.

Contaminant particles 146 that either float on top of the liquid film 106 or are entrained within the film but not adhered to the optical surface 100 will be relatively easily removable when the wiper 122 traverses the surface. However, some contaminant particles such as shown at 146′ may adhere to the optical surface 100. These contaminant particles may be more difficult to dislodge. In this embodiment the edge 124 of the wiper 122 comprises a sufficiently rigid material selected to resist deformation that would permit contaminants to pass under the wiper while traversing the optical surface. In some embodiments where the wiper 122 is fabricated from a thermoplastic material, the material may be selected to have a sufficiently high durometer to resist deformation of the edge 124. As an example, it has been found by the inventors that a thermoplastic material having a Shore A durometer of at least 90, is sufficiently rigid to prevent many common contaminants 146 from passing under the edge 124 of the wiper 122.

Some tenacious contaminants, such as tree sap or resin, can be very difficult to dislodge once adhered to the optical surface 100. In embodiments where the likely contaminants 146 include these more tenacious contaminants, the wiper may be fabricated from a metallic material. Optical engineers would typically be reluctant to deliberately bring a metallic material into contact with an optical surface. However, the inventors have found that the metallic wipers can be very effective in removal of very tenacious contaminants that would typically pass under a more compliant wiper and remain adhered to the cleaned portion 116 of the optical surface 100. The optical surface 100 of the window 104 will generally have surface height variance between highest and lowest points on the surface. In the absence of the liquid film 106, small particles trapped within the valleys in the optical surface 100 could be dragged across the optical surface 100 by a hard edged wiper 122, causing scratching of scuffing of the optical surface. The presence of the liquid film 106 thus prevents damage to the optical surface 100 by the edge 124 of the wiper 122. Some examples of suitable metallic materials that can be used to form the edge 124 of the wiper 122 include brass alloys, stainless steel alloys, porous metal alloys, and porous metal alloys impregnated with a lubricant.

An edge portion of the wiper 122 and optical surface 100 are shown further enlarged in an insert 162 in FIG. 1B. In the insert 162, the trailing face 128 is shown to be disposed at an acute angle θ to the optical surface 100. The leading face 126 is disposed at an angle α to the optical surface 100, which in this embodiment is shown as an obtuse angle. The obtuse angle at the leading face 126 has the effect of causing contaminants to be lifted during traversal of the wiper 122 across the optical surface 100 (as shown for a contaminate particle 146″). In other embodiments the angle α may be 90° or less. The angles α and θ are selected to cause the edge 124 of the wiper 122 to maintain a well-defined area of contact 164 at the edge 124 when urged into contact with the optical surface 100 by the force F. If an angle θ between the leading face 126 and trailing face 128 becomes too small, the edge 124 could be subject to deflection by the force F, which could cause the area of contact 164 to vary in shape and size. As an example, the area of contact 164 may be become rounded or the force F may cause the leading face 126 to be higher than the trailing face 128. In either of these cases the area of contact 164 may change during operation, which may permit some contaminants to pass under the wiper 122 into the region of the liquid applicator 152. Generally, the leading face 126 and trailing face 128 are formed to cause the area of contact 164 to have a uniformity generally corresponding to a surface roughness of the optical surface 100. Under these conditions, the area of contact 164 remains submerged within the film thickness T of the liquid film 106 as the wiper 122 traverses the optical surface 100. In one embodiment, the optical surface 100 may be a Schott borosilicate optical window, which has a surface roughness of approximately 25 nanometers. The area of contact 164 of the edge 124 may be processed by surface grinding, lapping, or polishing to a roughness generally comparable to the roughness of the optical surface.

In this embodiment the apparatus 102 also includes a controller 172 for controlling operation of the actuator 132 and the optical device 112. After a period of time in operation, contaminants will become entrained in a portion of the liquid film 106 extending across a field of view (indicated by markers 120) of the optical device 112, which will have an effect on optical performance. The controller 172 causes the actuator 132 to be activated to commence a cleaning process by causing the traversing movement 144 of the optical surface 100 with respect to the wiper 122. During the traversing movement 144 the contaminants 146, 146′, and 146″ are dislodged and lifted by the leading face 126 of the wiper 122 along with the portions of the existing liquid film 106 on the portion of the optical surface 100 being cleaned. In some embodiments, the controller 172 may be configured to implement a pre-determined period of time between initiating subsequent cleaning processes. The period of time may be selected such that an effectively continuous clear view is provided for the field of view 120 through the optical surface 100. In other embodiments the controller 172 may monitor images generated by the optical device 112 and the controller may be further configured to determine that a level of contamination has reached a threshold that would impede image quality. When this condition occurs the controller 172 activates the actuator 132 to begin the cleaning process. In other embodiments the controller 172 may be omitted and the cleaning process may be otherwise initiated, for example by a simple timer circuit.

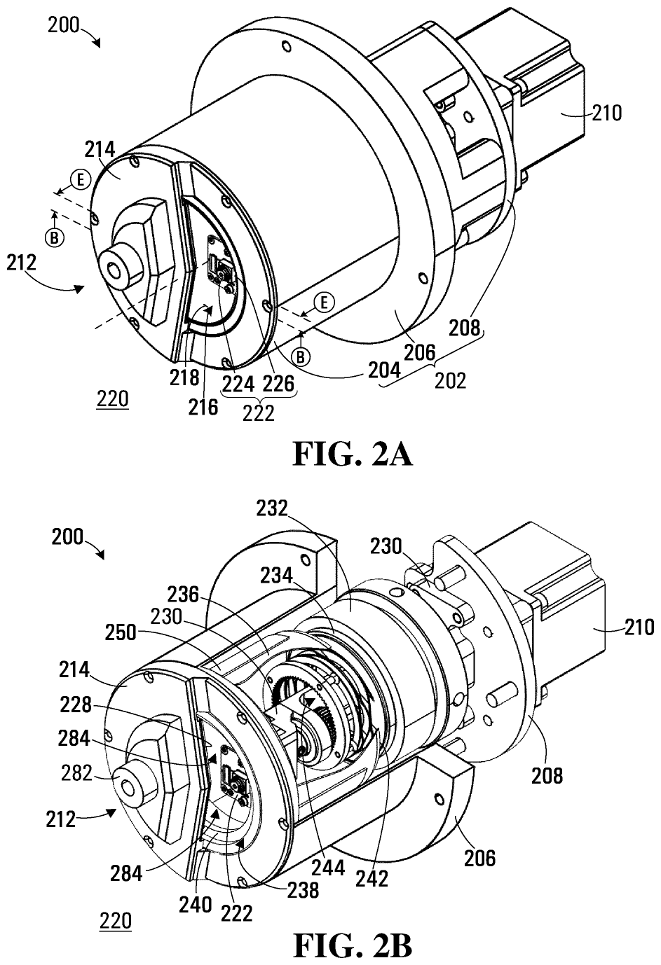

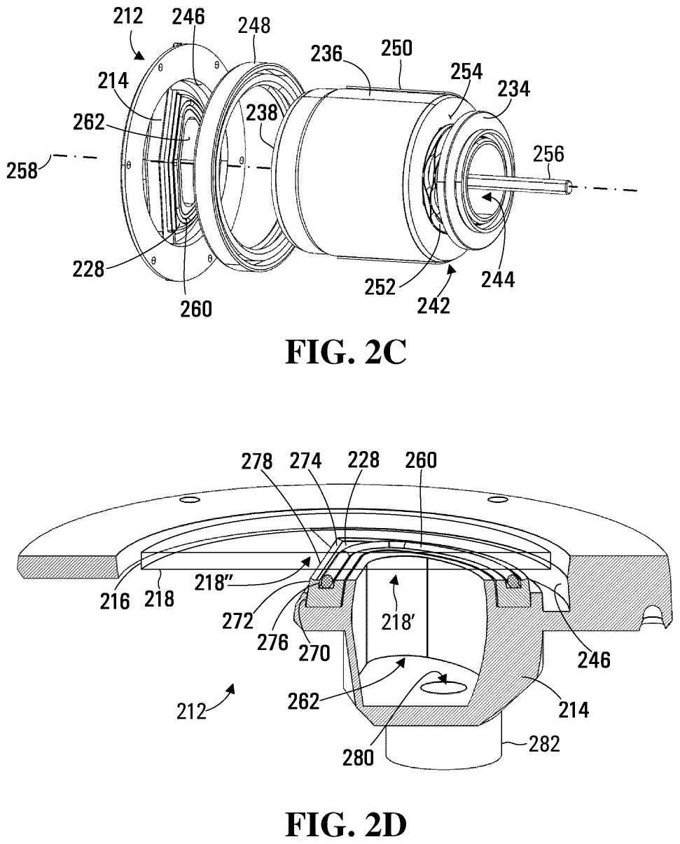

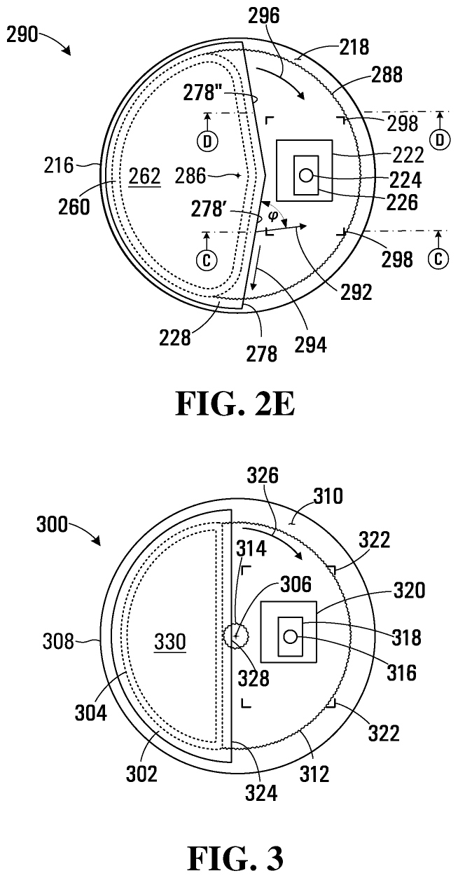

Referring to FIG. 2A, an embodiment of an integrated optical system is shown at 200. The optical system 200 includes an outer housing 202, which includes a nose portion 204 that extends outwardly from a mounting flange 206. The outer housing 202 also has a portion extending rearwardly from the flange 206. The rearwardly extending portion terminates in a mounting plate 208. The optical system 200 further includes an actuator 210 mounted on a rear surface of the mounting plate 208.

The optical system 200 also includes cleaning apparatus 212, which is enclosed in a housing 214 mounted to a distal portion of the nose portion 204 of the outer housing 202. The nose portion 204 includes a window 216. The window 216 and the nose portion 204 together with the outer housing 202 enclose various components of the optical system 200, including a camera 222. The window 216 provides an outwardly disposed optical surface 218, which is exposed to an environment 220. In this embodiment the camera 222 is implemented as a miniaturized camera module that has an integrated imaging lens 224 in front of a CMOS image sensor 226. In other embodiments the camera 222 may be implemented using any of a wide variety of image sensors.

The optical system 200 may be mounted in an opening in a panel such that the nose portion 204 protrudes through the panel and the flange 206 and the actuator 210 are disposed behind the panel. The actuator 210 would thus be protected by the panel, while the nose portion 204 would be disposed facing outwardly to provide the camera 222 with an unobstructed field of view through the window 216. In one embodiment the panel may be a portion of a vehicle and the nose portion 204 would thus be disposed to capture images of the environment 220 surrounding the vehicle.

Referring to FIG. 2B, the optical system 200 is shown in a partially cut-away view in FIG. 2B to reveal further components within the nose portion 204 of the outer housing 202. The housing 214 encloses a wiper 228 and a liquid applicator of the cleaning apparatus 212. The liquid applicator is not visible in FIG. 2B and will be described later herein. The housing 214 of the cleaning apparatus 212 is securely mounted to the nose portion 204 of the outer housing 202 via a plurality of fasteners. In this embodiment the camera 222 is mounted on a stem 230, which is in turn mounted to the mounting plate 208 of the outer housing 202. The stem 230 terminates within an inner housing 236, which encloses the camera 222. The inner housing 236 has an opening at an end 238 closest to the cleaning apparatus 212, and the window 216 is received and secured in a recess 240 within the opening. An opposite end 242 of the inner housing 236 has an opening 244, through which the stem 230 extends into the inner housing. The inner housing 236 is received within a bushing 250, which has an outer diameter sized for a press fit within the nose portion 204 of the outer housing 202. The bushing 250 provides a low friction inner surface that permits the inner housing 236 to rotate freely within the bushing. In other embodiments the bushing may be omitted in favor of a bearing. The optical system 200 also includes a bearing cup 232, which is mounted to a rear surface of the flange 206. The bearing cup 232 provides a mounting for a thrust bearing 234. The stem 230 extends through the bearing cup 232 and the thrust bearing 234 into the inner housing 236.

Referring to FIG. 2C, the cleaning apparatus 212, the inner housing 236, and the bearing 234 are shown in an exploded rear perspective view. The inner housing 236 is inserted into the cleaning apparatus 212 and the end 238 is received within a bore 246 formed in the housing 214. The bushing 250 (shown in part in FIG. 2C) prevents lateral motion of the inner housing 236 and allows the housing and window to rotate freely within the bore 246 about a longitudinal axis 258. In this embodiment the optical system 200 also includes a seal 248. When the optical system 200 is assembled, the seal 248 is held in place by the outer housing 202 (not shown in FIG. 2C) and seals between the cleaning apparatus 212 and an outer cylindrical surface of the inner housing 236. The seal 248 reduces the possibility of ingress of debris from the environment 220 into the bore 246, which may eventually cause the end 238 of the inner housing 236 to seize within the bore. The seal 248 also prevents liquids from entering the outer housing 202 and/or inner housing 236 and causing damage to electronics or other sensitive components within.

The optical system 200 further includes a spring 252, which is disposed between the inner housing 236 and the bearing 234. The spring 252 bears on a surface 254 at the end 242 of the inner housing 236, and when assembled provides a force directed generally along the longitudinal axis 258. The thrust bearing 234 transmits axial forces provided by the spring to the inner housing 236 while permitting free rotation of the inner housing within the bushing 250. The axial force urges the end 238 of the inner housing 236 toward the cleaning apparatus 212. The optical system 200 further includes an actuator shaft 256, which is coupled to the actuator 210 (shown in FIGS. 2A and 2B) and extends through the opening 244 into the inner housing 236. Referring back to FIG. 2B, the actuator shaft 256 terminates in a gear 266, which meshes with a ring gear 268. The ring gear 268 is fixed to the end 242 of the inner housing 236 and causes the inner housing and the window 216 to rotate when the actuator is activated to supply a rotational torque via the actuator shaft 256.

The cleaning apparatus 212 is shown in a perspective cross-sectional view in FIG. 2D taken along the line B-B in FIG. 2A. Referring to FIG. 2D, the inner housing 236 has been omitted in FIG. 2D for sake of illustration, but would occupy the gap between the window 216 and the bore 246 of the cleaning apparatus 212. The cleaning apparatus 212 has a generally “D” shaped groove 270 formed in a portion of the cleaning apparatus 212 facing the optical surface 218 of the window 216. The groove 270 receives the wiper 228. The wiper 228 includes a leading face 272 and a trailing face 274, which together define an edge 278 generally as described above in connection with FIG. 1B.

The wiper 228 includes a narrow generally “D” shaped groove 276, which receives an o-ring 260. The o-ring 260 surrounds a liquid reservoir 262 and acts as a fluid applicator. The liquid reservoir 262 holds a quantity of liquid for applying and replenishing a liquid film on the optical surface 218, generally as described above in connection with the embodiment shown in FIGS. 1A and 1B.

When the inner housing 236 and window 216 are inserted into the cleaning apparatus 212, the optical surface 218 engages the edge 278 of the wiper 228. The spring 252 provides a force aligned with the longitudinal axis 258 that urges the optical surface 218 of the window 216 into close proximity with the edge 278 of the wiper 228. In some embodiments the force provided by the spring may be made adjustable during assembly of the apparatus 102, such that the force may be adjusted to a target value. The target value may be selected to provide effective cleaning of the optical surface 218 based on expected level of contamination of the optical surface 218 and to achieve an optimal lifetime of the wiper 228 and o-ring 260. The force provided by the spring 252 also causes the optical surface 218 of the window 216 to slightly compress the o-ring 260 within the groove 276. The liquid reservoir 262 is thus closed off by the optical surface 218, which places the liquid contents of the reservoir in fluid contact with a portion 218′ of the optical surface. The liquid reservoir 262 may be filled or re-filled through an opening 280 provided by a port 282 (also shown in FIG. 2B).

Under static conditions when the optical surface 218 is not moving with respect to the housing 214 of the cleaning apparatus 212, the compression of the o-ring 260 provides a sufficient seal to prevent liquid from escaping from the liquid reservoir 262. When the optical surface 218 moves with respect to the housing 214, a thin layer of liquid remains on a portion of the optical surface 218′ that passes between the o-ring 260 and the optical surface. In this embodiment the compression of the o-ring 260 is limited by a distance between the edge 278 of the wiper 228 and the depth of the groove 276. A greater degree compression of the o-ring 260 would reduce a thickness of liquid that passes under the o-ring 260, while a lesser degree of compression would result in coating a thicker liquid film 106 on the optical surface. The o-ring 260 may also prevent contaminant particles that are able to pass under the edge 278 of the wiper 228 from entering the liquid reservoir.

The portion 218″ of the optical surface 218, when coated by a film of liquid from the liquid reservoir 262, thus forms a generally low friction contact with the wiper edge 278 and the o-ring 260. This low friction contact together with the bearing 234 at the inner end of the inner housing 236 facilitates rotation of the inner housing and window 216 within the bore 246 of the housing 214.

Referring back to FIG. 2B, if the inner housing 236 is rotated in a clockwise direction, a lower portion of the wiper 228 cleans contaminants from a portion of optical surface 218, while a cleaned portion 284 of the optical surface emerges at an upper portion of the wiper. As the optical surface 218 passes through the liquid reservoir, a liquid film is applied to the surface. The o-ring 260 together with the upper portion of the wiper 228 smooths and controls an applied thickness of the liquid film. Generally, it is desirable to maintain a relatively thin liquid film on the optical surface 218, to prevent runoff and/or optical distortion of light captured through the liquid film by the camera 222. During a cleaning cycle, the wiper 228 may leave some liquid on the optical surface 218, thus reducing the volume of liquid necessary for replenishment of the liquid film. Under these conditions, a relatively modest volume of liquid within of the liquid reservoir 262 would be sufficient for operation over an extended period of time, possibly even as long as the expected service lifetime of the apparatus 102. As an example, in one embodiment the quantity of liquid dispensed from the liquid reservoir 262 during each cleaning cycle may be about 0.0063 microliters and the reservoir capacity may be about 20 milliliters, thus providing capacity for several hundred thousand cleaning cycles, or more.

Referring to FIG. 2E, the window 216 and wiper 228 of the optical system 200 are shown in a front schematic view at 290 and a center of rotation of the window 216 is indicated at 286. In this embodiment the wiper 228 and o-ring 260 enclose the center of rotation 286. When the window 216 is rotated in the direction indicated by the arrow 296, a liquid film is applied by the o-ring 260 to the optical surface 218 from the liquid reservoir 262 within the wavy line 288. Additionally, the upper and lower portions of the edge 278 of the wiper on either side are disposed at an angle φ that is less than a right angle to a traversing direction of the wiper relative to the optical surface 218 (indicated by an arrow 292). For the circular geometry of the window 216 in this embodiment, the direction of motion 292 of each point along the edge 278 of the wiper 228 is concentric about the center 286. If the edge 278 were to be substantially aligned at a right angle to the direction of motion 292, accumulated contaminants would be pushed by the wiper 228 in concentric circles about the center 286. The angle φ has the advantage of causing dislodged contaminants to have an outward component of motion along the optical surface 310, as indicated by the arrow 294. The outwardly directed component of motion 294 causes contaminants that accumulate at the edge 278 to be swept outwardly toward a periphery of the optical surface 218.

The configuration of the imaging lens 224 and image sensor 226 of the camera 222 provides a field of view, indicated by the markers 298 in FIG. 2E. In this embodiment the wiper 228 is sized to cover as much of the optical surface 218 of the window 216 as possible, such that the liquid film 288 is close to a peripheral edge of the window 216. This has the advantage of maximizing the useable field of view 298 as a proportion of a total area of the optical surface 218.

The system configuration shown in FIG. 2E may be contrasted with the configuration example, shown schematically at 300 in FIG. 3. In this example, a cleaning apparatus 302 includes a wiper edge 324 and o-ring 304. The wiper edge 324 and o-ring 304 are outside of a center of rotation 306 of a window 308. In this case, when the window 308 is rotated in the direction indicated by the arrow 326, a liquid film is applied from a liquid reservoir 330 to an optical surface 310 of the window between the wavy lines 312 and 314. The applied liquid film thus leaves an area inside the line 314 uncoated by the liquid film due to the location of the center 306 being spaced apart from the wiper 302. Additionally, due to reduced motion of the optical surface 310 within the line 314, portions of the optical surface near the center 306 will also not be subjected to the same wiping action as portions further away from the center. A portion 328 of the wiper edge 324 within the line 314 thus bears directly on the optical surface 310 that has no liquid film. This may result in debris being dragged by the wiper edge 324 causing accelerated wear of the portion 328. The accelerated wear may permit debris to pass under the wiper edge 324 into a liquid reservoir 330 of the cleaning apparatus 302, thus potentially contaminating the liquid supply.

In FIG. 3, some portions of the field of view 322 also lie outside the periphery of the applied liquid film (i.e. outside the line 312) due to the limited lateral extent of the o-ring 304. In this example, the wiper 302 also has a straight edge extending almost through the center 306 of the optical surface 310, which would tend to move contaminants in concentric paths about the center. The outwardly directed component of motion imparted to the contaminants by the embodiment shown in FIG. 2E is thus missing in this example. Contaminant particles and/or water droplets after a rotational motion may thus accumulate at an edge 324 of the wiper 302 and may drip or run down within the field of view 322 after cleaning.

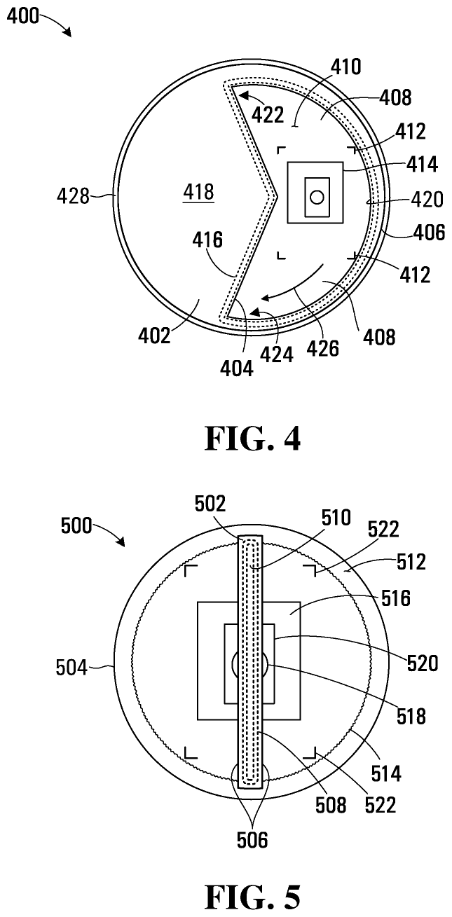

As described above in connection with FIG. 2C, the optical system 200 includes a seal 248 that prevents ingress of contaminants into the bore 246 and potentially into the inner housing 236 or outer housing 202. In an alternative embodiment, the seal 248 may be omitted or augmented by reconfiguring the o-ring 260 surrounding the liquid reservoir 262. Referring to FIG. 4, in the embodiment shown schematically at 400, a cleaning apparatus 402 has a wiper edge 404 for cleaning a circular window 408, generally configured as described above in connection with FIG. 2E. However, in this embodiment a portion 406 of the cleaning apparatus 402 extends around a periphery of the circular window 408. The portion 406 thus encloses a portion of an optical surface 410 of the window that provides a field of view 412 for a camera 414. In this embodiment an o-ring 416 extends along the wiper edge 404 as described above in connection with FIG. 2E, but also extends around the peripheral portion 406 of the cleaning apparatus 402. The o-ring 416 provides a first seal surrounding a liquid reservoir 418, which also extends around the peripheral portion 406 outside of the o-ring 416. In this embodiment an additional seal such as an o-ring 428 would be used to contain liquid within the reservoir 418 at the peripheral edges of the cleaning apparatus 402. The peripheral portion 406 of the cleaning apparatus 402 has an edge 420, which may be configured to protect the o-ring 416. In this embodiment, contaminants are thus prevented from entering the reservoir 418 by the combination of the wiper edges 404, 420 and the o-ring 416, generally as described above in connection with the embodiment of FIG. 2D. Since contaminants are prevented from entering the reservoir 418, contaminants will also be prevented from entering the outer housing when the cleaning apparatus 402 is mounted to an outer housing such as shown at 202 in FIG. 2A.

Additionally, in the embodiment shown in FIG. 4 the peripheral portion 406 progressively narrows from a first end 422 to a second end 424 of the peripheral portion. This progressive narrowing of the peripheral portion 406 has the effect of preventing contaminants from accumulating at the edge 420 of the peripheral portion. For a direction of motion of the window 408 indicated by the arrow 426, contaminants that are initially located on the window 408 at the wiper edge 420 proximate the end 422 will move inwardly with respect to the wiper edge as the portion 406 of the cleaning apparatus 402 narrows. The narrowing of the portion 406 thus prevents contaminants from accumulating at the wiper edge 420, which could cause wear of the wiper edge 420 and or o-ring 416 and also possibly impede free rotation of the window. This also has the effect of preventing buildup of contaminants directly at the wiper edge 420, which reduces the likelihood that these contaminants will pass under the wiper and into the liquid reservoir 418. This embodiment may be implemented in place of or in addition to the seal 248 shown in FIG. 2C of the optical system 200.

Referring to FIG. 5, an alternative cleaning apparatus embodiment is shown schematically at 500. In this embodiment a narrow wiper 502 is disposed centrally with respect to a circular window 504. The wiper 502 includes edges 506 on either side of the wiper. The configuration of the edges 506 may be generally as described above in connection with other disclosed embodiments. An o-ring 508 is disposed in a groove within the wiper and encloses a liquid reservoir 510, which dispenses liquid for forming a liquid film on an optical surface 512 of the window 504 (i.e. within the wavy line 514). In this embodiment a camera 516 is located such that its lens 518 and image sensor 520 are located centrally with respect to the window 504. The lens 518 and image sensor 520 define a field of view 522 that extends over a larger portion of the wiper 502 than for the embodiments described above. However, in this embodiment the field of view 522 is partially obscured by the wiper 502. The wiper 502 thus vignettes a first portion of light impinging on the portions of the optical surface 512 covered by the wiper 502. A second portion of light within the field of view of the camera 516 is transmitted by the optical surface 512. However, for a sufficiently narrow wiper 502 the second portion of light is sufficient to produce an image of the field of view 522 at image sensor 520. A flat field correction may be performed to correct for darker areas which will occur at the center of the field of view 522. This embodiment may be implemented in cases where requirements to miniaturize an overall size of the optical device outweighs the need for optimal image quality. In this embodiment, space for accommodating the cleaning apparatus in front of the window is significantly reduced.

Referring back to FIG. 2E, in the embodiment described the wiper 228 includes an edge 278 that has a lower portion 278′ and an upper portion 278″. The portions 278′ and 278″ each extend from a point near the center of rotation 286 at different angles. For rotation of the window 216 in the direction shown at 296, the lower edge portion 278′ performs the wiping action, while the liquid film 288 is dispensed from the liquid reservoir 262 along the edge 278″. The edge 278′ thus has requirements as described above in connection with the edge 124 of the wiper 122 shown in FIGS. 1A and 1B. While the edges 278′ and 278″ may be identical in some embodiments, this is not necessary or optimal in some embodiments since the respective edges have different functional requirements.

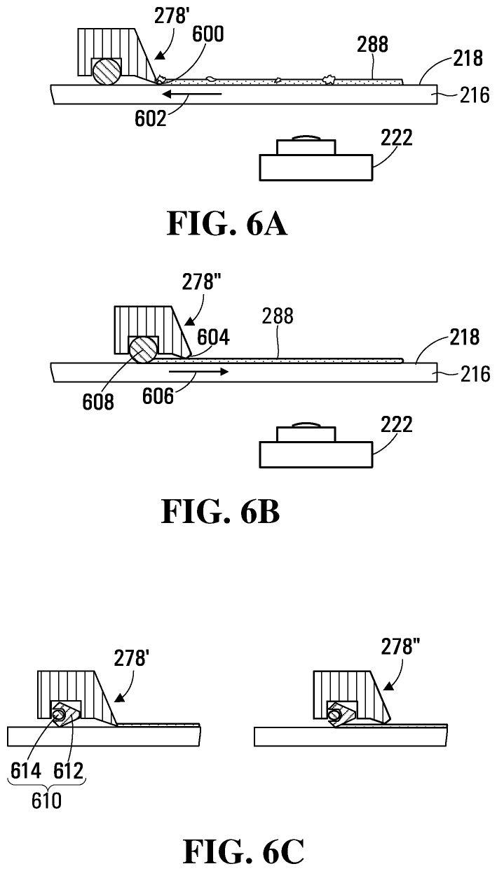

A cross section taken along the line C-C in FIG. 2E is shown in FIG. 6A and a cross section taken along the line D-D is shown in FIG. 6B. Referring to FIG. 6A, the lower wiper portion 278′ is configured for performing the wiping action when the window 216 moves in the direction indicated by the arrow 602 with respect to the wiper. An edge 600 of the wiper portion 278′ thus closely contacts the optical surface 218 as described above. Referring to FIG. 6B, in this embodiment the upper wiper portion 278″ has an edge 604 that is slightly spaced apart from the optical surface 218. An o-ring 608 dispenses a thin film of liquid under the o-ring generally as described in the embodiments above, and thus acts as a liquid applicator. When the window 216 moves in a direction indicated by the arrow 606 with respect to the wiper portion 278″, liquid is dispensed from a reservoir onto the optical surface 218 and flows under the edge 604. In some embodiments the edge 604 may be sufficiently spaced apart from the optical surface 218 so as not to affect a thickness of the liquid film 288 being applied by the o-ring 608. In other embodiments, the edge 604 may be configured to smooth out the liquid dispensed from the reservoir to provide a substantially uniform thickness of the liquid film 288. The configuration shown in FIG. 6B for the wiper portion 278″ is thus configured to prevent the edge 604 from adversely impacting the thickness of the liquid layer 288 being applied by the o-ring 608. In other embodiments where the effect of the wiper portion 278″ on the liquid film 288 is not an issue, the portions 278′ and 278″ may be similarly configured to simplify manufacturing.

Referring to FIG. 6C, in an alternative embodiment the wiper portions 278 and 278″ each include an energized seal 610 in place of the o-ring 608 shown in FIGS. 6B and 6C. The energized seal 610 is a compliant seal having an elastomeric portion 612 and an energizing portion 614. In this embodiment the energizing portion 614 is provided by an o-ring and is operably configured to urge the elastomeric portion 612 into contact with the optical surface 218. The energized seal 610 has some advantages over an o-ring seal. For implementations where the edge 600 is a hard material such as brass, imperfections or damage to the edge may allow small contaminant particles to pass under the edge an impinge on the o-ring 260 (FIG. 2D). The o-ring 260 seal is likely to lift slightly when liquid or contaminants engage the seal. The degree of lifting is also dependent on the traversing speed between the window and wiper. An increased speed causes the o-ring to be lifted more by the liquid passing under the seal. The energized seal 610 overcomes some of these disadvantages. One particular advantage is that material of the elastomeric portion 612 may be selected for a desired stiffness, while the material of the energizing portion 614 may be selected to provide a desired urging force. For an o-ring seal, material selection is usually a tradeoff between the stiffness and urging force requirements.

The edge 604 acts as an applicator shield and provides some measure of protection for the energized seal 610. For example, in some implementations the optical system 200 may need to withstand washing from the outside with a pressurized jet of water. The applicator blade edge 604 prevents the water jet from impinging directly on the energized seal 610, which could cause the seal to be dislodged or cause water to be forced into the liquid reservoir 262 under the seal.

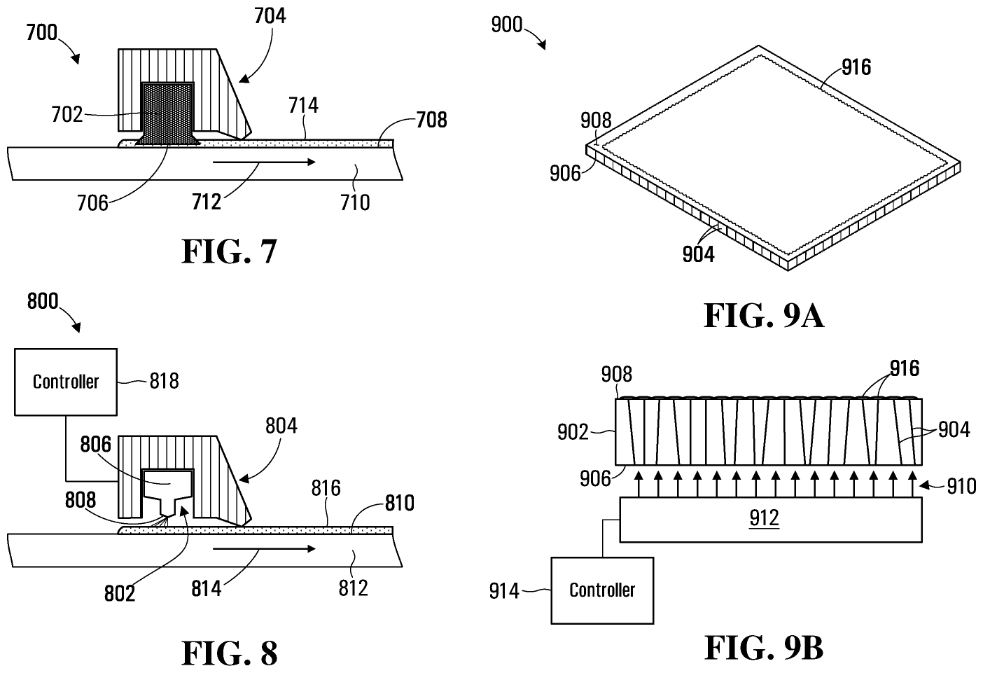

In the embodiment described in FIGS. 2A-2E, the dispensing of the liquid for forming the liquid film 288 after wiping is controlled by the o-ring 260 and the wiper edge 278. Liquid within the liquid reservoir 262 is in contact with the optical surface 218 of the window 216, and is effectively metered out by the o-ring 260 when the window is rotated. Referring to FIG. 7, an alternative liquid applicator embodiment is shown in cross section generally at 700. In this embodiment an absorbent material 702 within a wiper 704 replaces the o-ring or energized seal of the embodiments described above. The absorbent material 702 has a dispensing surface 706 in contact or proximate to an optical surface 708 of a window 710. The absorbent material 702 may also act as a reservoir for holding the liquid. For example, the absorbent material 702 may be a textile material such as felt having a bulk volume that may be saturated with the liquid. Felt material has narrow capillaries that act to convey liquid from the volume to the dispensing surface 706. Alternatively, the absorbent material 702 may be placed in fluid communication with a liquid reservoir (not shown), in which case the absorbent material essentially acts as a wick for conveying liquid between the reservoir and the dispensing surface 706. When the window 710 moves in a direction indicated by the arrow 712, a portion of the liquid is dispensed from the absorbent material for renewing a liquid film 714 on the optical surface 708.

Referring to FIG. 8, another liquid applicator embodiment is shown in cross section generally at 800. In this embodiment, the liquid is dispensed by a sprayer 802 located within a wiper 804. The sprayer 802 includes a liquid reservoir 806 and a nozzle 808 oriented toward an optical surface 810 of a window 812.

When the window 812 moves in a direction indicated by the arrow 814, liquid from the liquid reservoir 806 is sprayed through the nozzle 808 directly onto the optical surface 810. An amount of liquid dispensed may be controlled by a controller 818 configured to control operation of the sprayer 802. In one embodiment the sprayer 802 may be implemented as a plurality of piezoelectric or thermally excited nozzles, such as used in inkjet printers.

Referring to FIG. 9A, a further liquid applicator embodiment shown generally at 900. In this embodiment, a window 902 includes a plurality of narrow channels 904 extending through the window between surfaces 906 and 908 of the window 902, where the surface 908 acts as an optical surface exposed to the environment. A portion of the window 902 is shown in FIG. 9B in cross section. Referring to FIG. 9B, the liquid applicator 900 includes a liquid reservoir 912, which is communication with a controller 914. Liquid 910 is supplied to the surface 906 from the liquid reservoir 912. The channels 904 each have respective openings at the surface 906 and are operable to convey liquid from the liquid reservoir 912 to the optical surface 908 for renewing a liquid film 916 on the optical surface 908. In one embodiment the controller 914 causes the liquid reservoir 912 to be pressurized to a pressure level that is sufficient to cause liquid to flow through the narrow channels 904 to form the liquid film 916 on the optical surface. The controller 914 maintains a pressure on the liquid reservoir 912 sufficient to push the liquid through the channels 904, while not providing sufficient pressure to overcome a surface tension in the liquid film 916. Continuous flow of liquid onto the surface 908 may thus be prevented by either selectively applying or controlling the pressure. Alternatively, the controller 914 may be configured to maintain a pressure that is substantially equivalent to a surface tension of the liquid film 916 on the optical surface 908 to create an equilibrium at the liquid film. In this case, as liquid is removed by any of the wipers disclosed above, liquid is pushed to the surface 908 to replenish the liquid film 916.

The narrow channels 904 in the window 902 may be sized to have minimal effect on light transmission through the window. Additionally, the liquid may be selected that has a refractive index comparable to the window material, which will further reduce the optical effect of the channels.

The channels 904 may be formed during fabrication of the window. For example, micro-iron needles may be mixed in with a molten glass material and oriented by application of a magnetic field to the mixture while still molten. The magnetic field is oriented to cause the micro-iron needles to align between the surface 906 and optical surface 908, following which the molten material is allowed to cool. Finally, an etching step is performed using a chemical solution to dissolve the micro-iron needles, thus opening up the channels 904 within the window material. Alternatively, needles that are not necessarily magnetic may be longer than the desired thickness of the window and may be oriented using an external jig, prior to an etching step using an appropriate chemical solution.

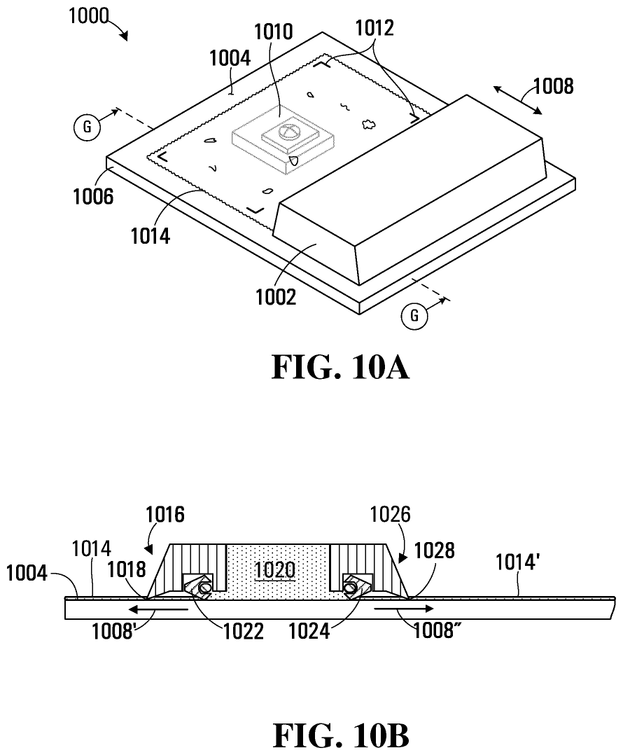

The above embodiments are described for relative rotational movement between wiper and the window. In an alternative embodiment shown in FIG. 10A at 1000, a cleaning apparatus 1002 is configured for linear motion over a generally rectangular optical surface 1004 of a window 1006. A linear actuator, such as a leadscrew (not shown) may be implemented to move the cleaning apparatus 1002 back and forth in a direction indicated by an arrow 1008. An optical device 1010 is disposed to capture or direct light through a field of view, indicated by markers 1012. The field of view 1012 of the optical surface 1004 is covered by an optically transparent liquid film 1014, disposed to protect the optical surface while transmitting light to the underlying camera 1010.

Referring to FIG. 10B, the cleaning apparatus 1002 is shown in a partial cross sectional view taken along the line G-G in FIG. 10A. The cleaning apparatus 1002 includes a leading wiper 1016, which includes an edge 1018 generally configured as described above. When the cleaning apparatus 1002 is moved in a first direction 1008′ along the optical surface 1004, the edge 1018 dislodges and lifts contaminants that fall on the liquid film 1014, which are moved out of the field of view 1012. The cleaning apparatus 1002 also includes a liquid reservoir 1020, which holds a quantity of liquid for replenishing the liquid film 1014. The leading wiper 1016 includes energized seals 1022 and 1024, which dispense liquid from the liquid reservoir 1020 during the motion of the cleaning apparatus 1002.

The cleaning apparatus 1002 also includes a trailing wiper 1026 having an edge 1028. During the motion in the direction 1008′ the energized seal 1024 dispenses a liquid film 1014′ on the optical surface 1004. The liquid film 1014′ protects the underlying optical surface 1004 during movement of the cleaning apparatus 1002 in the direction 1008′. The edge 1028 protects the energized seal 1024, and in some embodiments may be spaced apart from the optical surface 1004, rather than in contact with the optical surface.

Following the linear motion in the direction 1008′, the motion of the cleaning apparatus 1002 is reversed and the cleaning apparatus moves in the direction 1008″. The energized seal 1022 dispenses liquid from the liquid reservoir 1020, which replenishes the liquid film 1014 covering the field of view 1012 of the camera 1010. In the embodiment shown, the cleaning apparatus 1002 and edge 1018 of the leading wiper 1016 are disposed at substantially a right angle to the direction of motion 1008. In other embodiments the edge 1018 of the wiper 1016 may be disposed at an angle that is less than a right angle to the movement direction, such that dislodged contaminants are moved along the optical surface with a component of motion along the edge of the wiper.

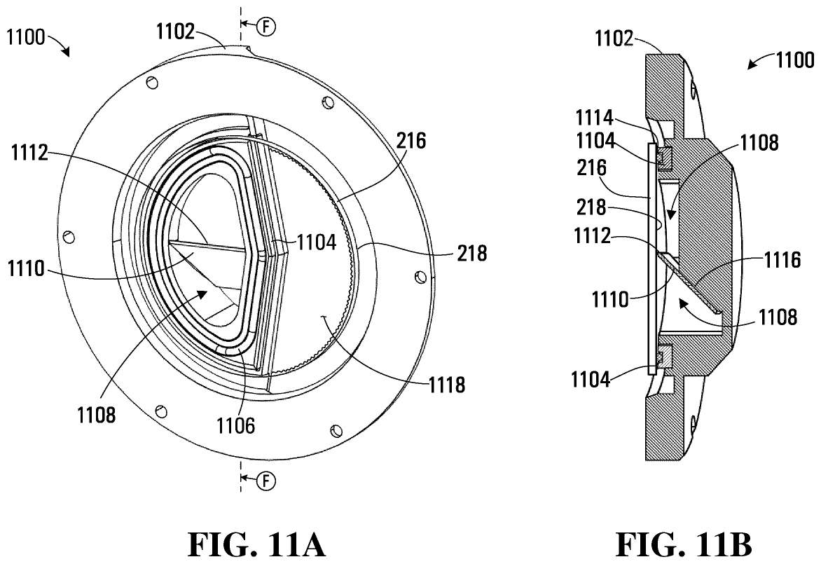

Referring to FIG. 11A an alternative embodiment of a cleaning apparatus is shown generally at 1100. The cleaning apparatus 1100 is enclosed within a housing 1102, which may be mounted to the nose portion 204 of the optical system 200 shown in FIG. 2A in place of the cleaning apparatus 212. In FIG. 11A, the cleaning apparatus 1100 is shown in a perspective view from behind the housing 1102, as indicated by the line E-E in FIG. 2A. The window 216 is configured generally as described above with the optical surface 218 shown facing into the page. Other elements of the optical system 200 (not shown in FIG. 11A) are configured generally as described above in connection with FIGS. 2A and 2B.

The cleaning apparatus 1100 includes a first wiper 1104 and an o-ring 1106, which may be similarly configured to the wiper 228 and o-ring 260 of the cleaning apparatus 212. The housing 1102 encloses a liquid reservoir 1108, which is surrounded by the o-ring 1106, which bears on the optical surface 218 of the window 216. The liquid reservoir 1108 is configured to hold a quantity of liquid for applying and replenishing a liquid film 1118 on the optical surface 218, generally as described above. The cleaning apparatus 1100 further includes an additional second wiper 1110, which in this embodiment is disposed internally within the reservoir and has an edge 1112 in contact with the optical surface 218. The second wiper 1110 is fabricated from a sufficiently rigid material that resists deformation that would permit contaminants to pass under the wiper while traversing the optical surface 218. In one embodiment the second wiper 1110 may be fabricated from a metallic material, such as brass or stainless steel, while the first wiper 1104 may be fabricated from a less rigid material having some compliance. As an example, the first wiper 1104 may be fabricated from polyurethane, having a Shore A durometer of about 90 to 95.

Referring to FIG. 11B, the cleaning apparatus 1100 is shown in cross section taken along the line F-F in FIG. 11A. The optical surface 218 of the window 216 is simultaneously urged into engagement with an edge 1114 of the first wiper 1104, the edge 1112 of the second wiper 1110, and the o-ring 1106. The edge 1112 of the second wiper 1110 may be configured generally as described above in connection with FIG. 1B. The second wiper 1110 is mounted on an angled surface 1116 within the liquid reservoir 1108. The liquid reservoir 1108 extends to either side of the second wiper 1110, and in this embodiment the wiper is thus immersed within the liquid reservoir. In other embodiments the additional second wiper 1110 may be located outside the reservoir.

The cleaning apparatus 1100 operates generally as described above, in that the window 216 is rotated relative to the housing 1102. The rotation causes the edge 1114 of the first wiper 1104 to lift contaminant particles floating one or within the liquid film 1118, thus cleaning the optical surface 218. Some contaminant particles that are more strongly adhered to the optical surface 218 may not be dislodged by the edge 1114 of the first wiper 1104, which may permit the particles to pass under the wiper edge due to the compliance of the wiper. The edge 1112 of the more rigid second wiper 1110 will typically be more effective in removing stubbornly adhered contaminant particles. Once removed, these particles would remain suspended within the liquid reservoir 1108. The embodiment shown in FIGS. 11A and 11B has the advantage of using the more compliant edge 1114 of the first wiper 1104 to dislodge most contaminants, while the edge 1112 of the second wiper 1110 facilitates removal of more stubbornly adhered contaminants from the optical surface 218 of the window 216.

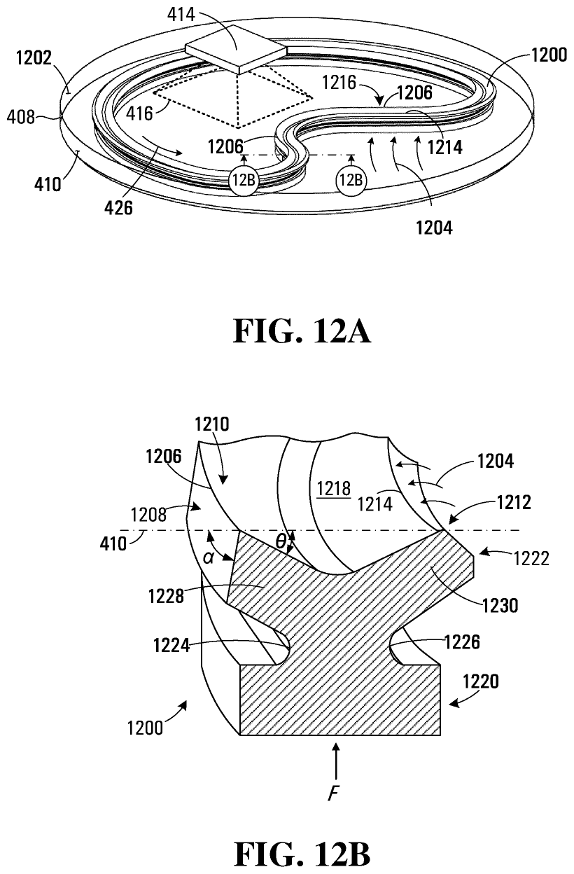

An alternative embodiment of a wiper for use in the apparatus shown in FIG. 4 is shown in FIG. 12A at 1200. Referring to FIG. 12A, the circular window 408 is shown disposed above the wiper 1200 in contact with the outwardly oriented optical surface 410 of the window, which is shown facing downwardly in FIG. 12A. An inner surface 1202 of the window 408 is shown facing upwardly and the camera 414 being protected by the window is disposed above this surface and shown from the rear. The field of view 412 of the camera is shown at 414 in broken lines. The wiper 1200 thus encloses the field of view 412 portion on the optical surface 410, through which the camera has a line of sight. The liquid reservoir is not shown in detail in FIG. 12A, but would be disposed to provide liquid from outside the ring of the wiper 1200 as shown by the arrows 1204. The wiper 1200 includes a wiper edge 1206 that extends across and is urged into close proximity with the optical surface 410. When the window 408 moves relative to the wiper 1200, the optical surface 410 moves under the edge 1206 of the wiper 1200 to dislodge contaminants entrained in the liquid film or adhered to the optical surface.

Referring to FIG. 12B, the wiper 1200 is shown in a cross section taken along the line 12B-12B in FIG. 12A. The wiper edge 1206 is defined between a leading face 1208 and a trailing face 1210. In this embodiment the leading face 1208 is initially disposed at an acute angle α to the optical surface 410 (shown as a broken line in FIG. 12B). The angles α and θ are selected to cause the wiper edge 1206 of the wiper 1200 to maintain a well-defined area of contact at the wiper edge when urged into contact with the optical surface 410.

In this embodiment the wiper 1200 includes an integral liquid applicator portion 1212 that includes a liquid applicator edge 1214. When the window 408 moves relative to the wiper 1200, the optical surface 410 emerges under the wiper edge 1206 of the wiper (at 1216 in FIG. 12A) and the applicator edge 1214 allows the liquid 1204 to move under the applicator edge. The liquid 1204 that flows under the applicator edge 1214 accumulates in a region 1218 between the wiper edge 1206 and applicator edge 1214 and the liquid is dispensed onto the optical surface 410 emerging at 1216, thus renewing the liquid film on the optical surface 410.

The wiper 1200 would generally be accommodated in a mounting groove, such as shown in FIG. 2D at 270. In the embodiment shown the wiper 1200 has a mounting portion 1220 that is received in the groove and an engagement portion 1222 that includes the edges 1206 and 1214. Between the mounting portion 1220 and the engagement portion 1222 are sculpted lateral portions 1224 and 1226. The sculpted portions 1224 and 1226 permit the engagement portion 1222 to flex laterally with respect to the mounting portion 1220 to permit the engagement portion to align such that both the wiper edge 1206 and applicator edge 1214 remain in contact with the optical surface 410. Together the mounting portion 1220 and wiper engagement portion 1222 form a unitary body including both the wiper edge 1206 and the liquid applicator edge 1214.

In the embodiment shown, the engagement portion 1222 of the wiper 1200 has a wiper arm 1228 and a liquid applicator arm 1230, which are defined by the sculpted portions 1224 and 1226. The wiper edge 1206 is disposed distally at an end of the wiper arm 1228, which is slightly thicker than the liquid applicator arm 1230. The wiper arm 1228 would thus be slightly less compliant than the liquid applicator arm 1230 and the wiper edge 1206 would be less likely to be deflected than the liquid applicator edge 1214. A depth of the groove is selected to cause the wiper arm 1228 and liquid applicator arm 1230 to be deflected by the optical surface 410 window 408 when the mounting portion 1220 of the wiper 1200 is received in the groove. The arms 1228 and 1230 cause the engagement portion 1222 of the wiper 1200 to contact the circular window 408 with a force F caused by the deflection of the compliant arms. In one embodiment the depth of the groove and the compliance of the wiper arm 1228 is selected such then when deflected by the window 408, the angle α increases from the initially acute angle shown in FIG. 12 to cause the leading face 1208 to be disposed at an angle that is at approximately a right angle or greater to the optical surface 410.

In one embodiment the wiper 1200 may be fabricated from a plastic material such as acetal (Hydroxyacetone) or polyurethane crosslinked to produce a hard polymer material that is sufficiently rigid to resist deformation that would permit contaminants to pass under the wiper 1200 while traversing the optical surface 410. For example, a 95A formulation of polyurethane may be used that has a Shore A durometer of 95. After molding of the wiper 1200 the wiper edge 1206 may further be ground or polished to provide an edge that is sufficiently well defined and hard enough to be capable of dislodging contaminants from the optical surface 410.

While specific embodiments have been described and illustrated, such embodiments should be considered illustrative only and not as limiting the disclosed embodiments as construed in accordance with the accompanying claims.

What is claimed is:

1. An apparatus for cleaning an optical surface, at least a portion of which is covered by an optically transparent liquid film, the liquid film disposed to protect the optical surface while transmitting light to an underlying optical device, the apparatus comprising:
a wiper including an edge extending across at least a portion of the optical surface and urged into close proximity with the optical surface, the edge being defined between a leading face and a trailing face;
an actuator operable to move of at least one of the wiper and the optical surface to cause the wiper to traverse the optical surface such that the leading face dislodges contaminants entrained in the liquid film or adhered to the optical surface to produce a cleaned portion of the optical surface;
a liquid applicator disposed to dispense liquid for renewing the liquid film on the cleaned portion of the optical surface; and
wherein the edge of the wiper comprises a sufficiently rigid material selected to resist deformation that would permit contaminants to pass under the wiper while traversing the optical surface.

2. The apparatus of claim 1 wherein the leading face is oriented at an obtuse angle to a portion of the optical surface to be traversed to dispose the leading face to lift the contaminants away from the optical surface while traversing.

3. The apparatus of claim 1 wherein the edge of the wiper is urged into close proximity with the optical surface by one of:
a compliant element configured to force the wiper and the optical surface toward each other;
a compliant element configured to provide an adjustable force for forcing the wiper and the optical surface toward each other; or
a material compliance associated with the edge of the wiper.

4. The apparatus of claim 1 wherein the optical device is disposed within an inner housing including a window disposed to protect the underlying optical device, and wherein the optical surface comprises a surface of the window, and wherein the wiper is mounted to an outer housing enclosing the first housing, and further comprising a compliant element disposed between the inner housing and the outer housing, the compliant element being configured to urge the first housing into contact with the wiper.

5. The apparatus of claim 1 wherein the edge of the wiper comprises a metallic material.

6. The apparatus of claim 1 wherein the edge of the wiper comprises a thermoplastic material having a Shore A durometer of at least 90.

7. The apparatus of claim 1 wherein the optical surface comprises a surface of a window disposed to protect the underlying optical device and wherein the actuator is operable to cause at least one of:
a rotation of the window; and
a linear displacement of the window.

8. The apparatus of claim 1 wherein the edge of the wiper is disposed at an angle that is less than a right angle to a traversing direction with respect to the optical surface, such that dislodged contaminants will have a component of motion along the edge of the wiper during traversing.

9. The apparatus of claim 1 wherein the optical surface comprises a surface of a circular window disposed to protect the underlying optical device, the optical device having a field of view through a portion of the window, and wherein the actuator is operable to cause a rotation of the window about a central axis, the central axis being disposed outside the field of view portion of the window.

10. The apparatus of claim 1 wherein the wiper and liquid applicator are enclosed within a housing that extends over a portion of the optical surface within a field of view of the optical device, the housing vignetting a first portion of light impinging on the optical surface while a second portion of light within the field of view of the optical device is transmitted by the optical surface, the second portion of light being sufficient to produce an image of the field of view of the optical device.

11. The apparatus of claim 1 wherein the actuator is configured to cause movement in a first direction to cause the leading face of the wiper to traverse the optical surface to produce the cleaned portion of the optical surface while the liquid applicator renews the liquid film on the cleaned portion of the optical surface.

12. The apparatus of claim 1 wherein the actuator is configured to cause movement in a first direction to cause the leading face of the wiper to traverse the optical surface to produce the cleaned portion of the optical surface, the actuator being further configured to cause movement in a second direction to cause the liquid applicator to renew the liquid film on the cleaned portion of the optical surface.

13. The apparatus of claim 1 wherein the trailing face of the wiper is disposed at an acute angle to the optical surface such that the respective angles of the leading face and trailing face define an area of contact at the edge for contacting the optical surface.

14. The apparatus of claim 13 wherein the leading face and trailing face of the wiper are formed to cause the area of contact to have a uniformity generally corresponding to a surface roughness of the optical surface such that the area of contact remains submerged within a film thickness of the liquid film as the wiper traverses the optical surface.

15. The apparatus of claim 1 wherein the liquid applicator comprises:
a liquid reservoir; and
a compliant seal disposed behind the trailing face of the wiper, the compliant seal being configured to dispense liquid from the liquid reservoir for renewing the liquid film.

16. The apparatus of claim 15 wherein the liquid reservoir includes an opening disposed proximate to the optical surface and wherein the compliant seal is configured to enclose the opening to limit discharge of the liquid from the liquid reservoir when the wiper is not moving relative to the optical surface.

17. The apparatus of claim 16 wherein the compliant seal includes a first portion disposed proximate the trailing face of the wiper and a second portion spaced apart from the trailing face, and further comprising an applicator shield extending along the second portion of the compliant seal, the applicator shield being operably configured to protect the second portion of the compliant seal and to prevent ingress of contaminants into the volume of the liquid reservoir.

18. The apparatus of claim 15 wherein the compliant seal comprises an energized seal having an elastomeric portion and an energizing portion, the energizing portion operably configured to urge the elastomeric portion into contact with the optical surface.

19. The apparatus of claim 1 wherein the liquid applicator comprises an absorbent material disposed in contact with or proximate the optical surface, the absorbent material acting as a reservoir for holding liquid, a portion of which is dispensed from the absorbent material for renewing the liquid film.

20. The apparatus of claim 1 wherein the liquid applicator comprises a spray nozzle in communication with a liquid reservoir, the spray nozzle being oriented to spray liquid onto the optical surface.

21. The apparatus of claim 1 wherein the optical surface is provided by an optical element disposed to transmit light to the optical device, the optical element including a plurality of narrow channels extending through the optical element and wherein the liquid applicator comprises a liquid reservoir in communication with the plurality of channels, the plurality of channels having respective openings at the optical surface operable to deliver liquid from the liquid reservoir to the optical surface for renewing the liquid film.

22. The apparatus of claim 21 wherein the liquid reservoir is pressurized to a pressure level that is sufficient to cause liquid to flow through the plurality of narrow channels and form the liquid film on the optical surface while not providing sufficient force to overcome the surface tension in the liquid film.

23. The apparatus of claim 1 wherein the optical surface comprises a surface of a circular window disposed to protect the underlying optical device, and wherein:
the apparatus further comprises a housing covering a portion of the optical surface and defining an opening corresponding to the portion of the optical surface covered by the optically transparent liquid film;
the wiper is disposed on the housing adjacent to the opening and extending outwardly from a location proximate a center of the circular window toward a periphery of the window;
the actuator is operably configured to cause the window to rotate relative to the housing to cause the wiper to dislodge contaminants on a portion of the optical surface that passes under the wiper into the housing; and
the liquid applicator is disposed to renew the liquid film on the cleaned portion of the optical surface that emerges from the housing.

24. The apparatus of claim 23 wherein the housing includes a peripheral portion that extends around the opening along a peripheral portion of the window such that the housing and the peripheral portion of the housing enclose the opening.

25. The apparatus of claim 24 wherein the housing includes a seal disposed surrounding the opening.

26. The apparatus of claim 24 wherein the peripheral portion of the housing progressively narrows in a direction of rotation of the window with respect to the housing such that contaminants on the optical surface become spaced apart from the peripheral portion of the housing as the window rotates relative to the housing.

27. The apparatus of claim 1, wherein the wiper comprises a first wiper and a second wiper, the second wiper including an edge comprising the sufficiently rigid material selected to resist deformation, the first wiper comprising an edge fabricated from a material having a greater compliance than the edge of the second wiper; and
wherein the second wiper is operably configured to dislodge contaminants that pass under the first wiper while traversing the optical surface.

28. The apparatus of claim 27 wherein the edge of the second wiper comprises a metallic material and wherein the edge of the first wiper comprises a thermoplastic material having a Shore A durometer of at least 90.

29. The apparatus of claim 1 wherein the wiper and liquid applicator are fabricated as a unitary body.

30. The apparatus of claim 29 wherein the liquid applicator comprises a liquid applicator edge disposed in spaced apart relation to the edge of the wiper, the liquid applicator edge being in liquid communication with a liquid reservoir for dispensing liquid under the liquid applicator edge and under the edge of the wiper onto the optical surface.

31. The apparatus of claim 29 wherein the unitary body comprises at least one laterally sculpted portion between a mounting portion and an engagement portion of the wiper, the at least one laterally sculpted portion being configured to facilitate flexing of the engagement portion with respect to the mounting portion to permit the edge of the wiper and the liquid applicator edge to each engage the optical surface.

32. The apparatus of claim 29 wherein the wiper is fabricated from one of a Hydroxyacetone or a polyurethane material.
